(19) United States
(12) Patent Application Publication
(10) Pub. No.: US 2009/0193778 A1
(43) Pub. Date: Aug. 6, 2009

(54) DISTRIBUTION OF MATERIAL DISCHARGED FROM A ROTARY MOWER

(76) Inventors: Todd Hofmann, Saskatoon (CA); Brian Siroski, Engelfeld (CA)

Correspondence Address: STITES & HARBISON PLLC, 1199 NORTH FAIRFAX STREET, SUITE 900, ALEXANDRIA, VA, 22314, US

(21) Appl. No.: 12/179,085

(22) Filed: Jul. 24, 2008

(30) Foreign Application Priority Data
Jan. 31, 2008 (CA) 2619409

(51) Int. Cl. A01D 34/82

(52) U.S. Cl. 56/320.2

(57) ABSTRACT

A rotary mower apparatus includes a mower deck, and a mower blade rotatably mounted under the mower deck about a substantially vertical axis of rotation. The mower blade follows a circular path having a radius equal to a cutting radius, and a baffle plate extends downward from the mower deck adjacent to and outside the circular path. A vertical position of a bottom edge of the baffle plate can be adjusted from a lowered position to a raised position. A deflector plate can be attached such that a front edge thereof is pivotally mounted to the mower deck rearward of the mower blade such that the deflector plate extends downward and rearward from the front edge thereof, and such that the deflector plate can pivot a lowered to a raised position and be supported at a selected location in the pivot range.

This invention is in the field of rotary mowers and in particular concerns improving the distribution of material cut by such mowers.

### BACKGROUND

Rotary mowers are used for cutting a wide variety of vegetation. Vegetation in roadside ditches is cut to provide visibility for motorists, prevent blowing snow from being trapped, and like reasons. The distribution of the cut material discharged from the mower is not usually of great concern, so long as it is not left in unsightly piles.

It is also becoming more popular to use rotary mowers in the agricultural industry to shred crop residue. Modern agricultural practices tend toward reducing tillage, such that it is no longer desirable to plow crop residue into the soil. Depending on the crop and the yield of the crop considerable crop residue can remain in a field after harvest. Excessive residue can interfere with planting operations when the next crop is planted, and so a rotary mower is often used to shred and spread the crop residue.

When shredding crop residue to prepare an agricultural field for planting it is desirable to spread the crop residue as evenly as possible across the surface of the field.

Planting equipment typically includes rows of furrow openers that engage the soil, and evenly distributed crop residue will more readily flow between the furrow openers and reduce the occurrence of crop residue gathering between the furrow openers and plugging the planter with crop residue.

Rotary mowers for field operations are commonly the wider mowers with a plurality of rotating blades. Rotary mowers typically include side plates at the outside ends of the mower that extend down below the blades to contain cut material. The front of the mower is open to allow the standing vegetation to enter freely, and the rear of the mower is open such that material discharges rearward as the mower moves through the vegetation. As a blade rotates it tends to throw cut vegetation in the direction of rotation and in a typical multiple blade mower some blades rotate in a clockwise direction, while others turn in a counterclockwise direction, in order to help distribute the cut material as evenly as possible across the width of the mower.

Baffles can be provided to further improve the even spread of cut material. The baffles comprise one or more baffle plates extending downward from the bottom surface of the mower deck just outside the path of the outer ends of the blades. The baffle is typically open on the front end to allow the standing vegetation to enter the path of the blade. The baffles extend down around a rear portion of the arc of the circle cut by the blade to contain and direct the cut material thrown by the blade.

The vegetation to be cut can vary significantly, from tall to short, dense to relatively thin, light weight to relatively heavier weight, and different types of vegetation react differently when cut. Working conditions also cause variations. For example the vegetation may be wet or dry due to weather conditions, time of cut, and so forth. The residue left by one type of crop will vary dramatically compared to the residue of a different crop. Thus cotton crop residue will be discharged from a mower in a different pattern than, for example, corn crop residue.

To achieve an even spread of cut material for a particular crop, mowers have been provided with a baffle configured in a particular way to best achieve an even spread in average conditions for the vegetation to be cut. By trial and error it is determined where on the arc of the circle cut by the blade the baffle should extend lower to contain the material, and where it should be raised to allow the material to be discharged, and then the baffle is configured in that way.

Rotary mowers typically include short lengths of safety chain hanging vertically down across the open front and rear ends of the mower in a curtain. These chains slow any rocks or like debris that might be thrown by the rapidly spinning blades and cause injury or damage to people or objects near the mower. The chains however can also interfere with the evenness of distribution of the discharged cut material. When there is a heavy flow of discharged material the chains can drag the material into piles.

### SUMMARY OF THE INVENTION

It is an object of the present invention to provide a rotary mower apparatus that overcomes problems in the prior art.

In a first embodiment the present invention provides a rotary mower apparatus comprising a mower deck, and a mower blade rotatably mounted under the mower deck about a substantially vertical axis of rotation. The mower blade follows a circular path having a radius equal to a cutting radius, and a baffle plate extends downward from the mower deck adjacent to the circular path and outside the circular path. A vertical position of a bottom edge of the baffle plate can be adjusted from a lowered position to a raised position.

In a second embodiment the present invention provides a rotary mower apparatus comprising a mower deck, and a mower blade rotatably mounted under the mower deck about a substantially vertical axis of rotation. A deflector plate has a front edge pivotally mounted about a substantially horizontal pivot axis to the mower deck rearward of the mower blade such that the deflector plate extends downward and rearward from the front edge thereof, and such that the deflector plate can pivot in a pivot range from a lowered position to a raised position. A support mechanism is operative to support the deflector plate at a selected location in the pivot range.

The adjustable baffle plates facilitate use of a mower for cutting a variety of vegetation. In the prior art where the baffle plates are fixed, the mower has limited utility for cutting vegetation other than that for which the baffle plates are configured. In the present invention the baffle plates can be adjusted to improve the spread of virtually any vegetation that could be encountered.

The deflector plate reduces restrictions on material discharged from the rear end of the mower, providing an improved smooth material flow, and also improved safety in that thrown debris contacts the solid deflector plate and is deflected down into the ground, whereas thrown debris can escape through the conventional curtain of safety chains.

### DESCRIPTION OF THE DRAWINGS

While the invention is claimed in the concluding portions hereof, preferred embodiments are provided in the accompanying detailed description which may be best understood in conjunction with the accompanying diagrams where like parts in each of the several diagrams are labeled with like numbers, and where:

FIG. 1 is a schematic bottom view of an embodiment of a rotary mower apparatus of the present invention;

FIG. 2 is a schematic side view of the embodiment of FIG. 1 with the baffle plate in a lowered position;

FIG. 3 is schematic bottom view of one mower deck of the embodiment of FIG. 1;

FIG. 4 is a schematic side view of the embodiment of FIG. 1 with one end of the baffle plate in a lowered position and the other end in a raised position;

FIG. 5 is a perspective view of a mounting plate in three portions adapted to be attached to the underside of a mower deck by bolts, and also illustrates baffle plates where the bottom edge is at an angle compared to the top edge;

FIG. 6 is a schematic perspective view of an outside rear corner of the embodiment of FIG. 1 showing the endplate to block the gap between the end of the deflector plate and the end of the sidewall of the mower deck.

FIGS. 7 and 8 are schematic side views of alternative embodiments of the support mechanism.

### DETAILED DESCRIPTION OF THE ILLUSTRATED EMBODIMENTS

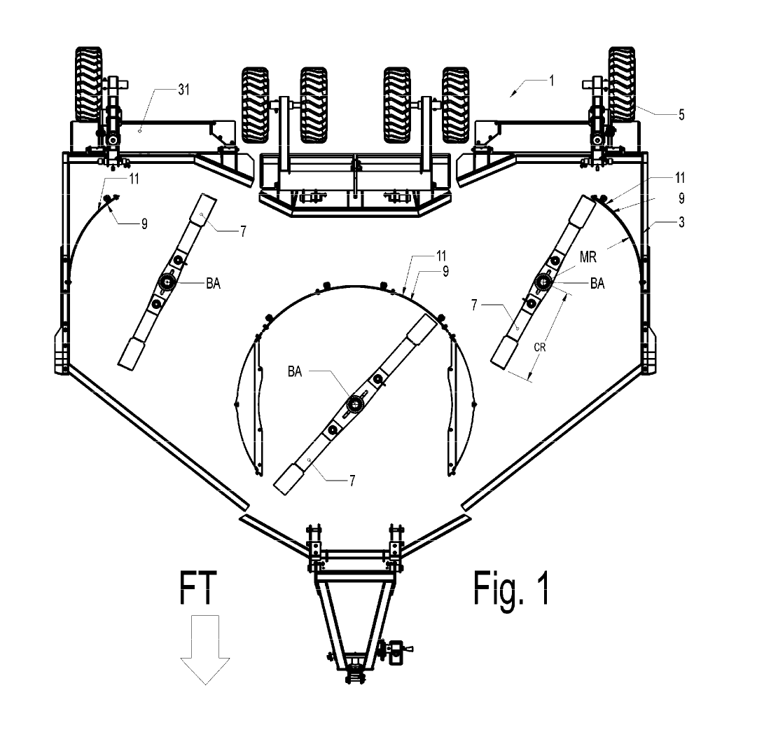

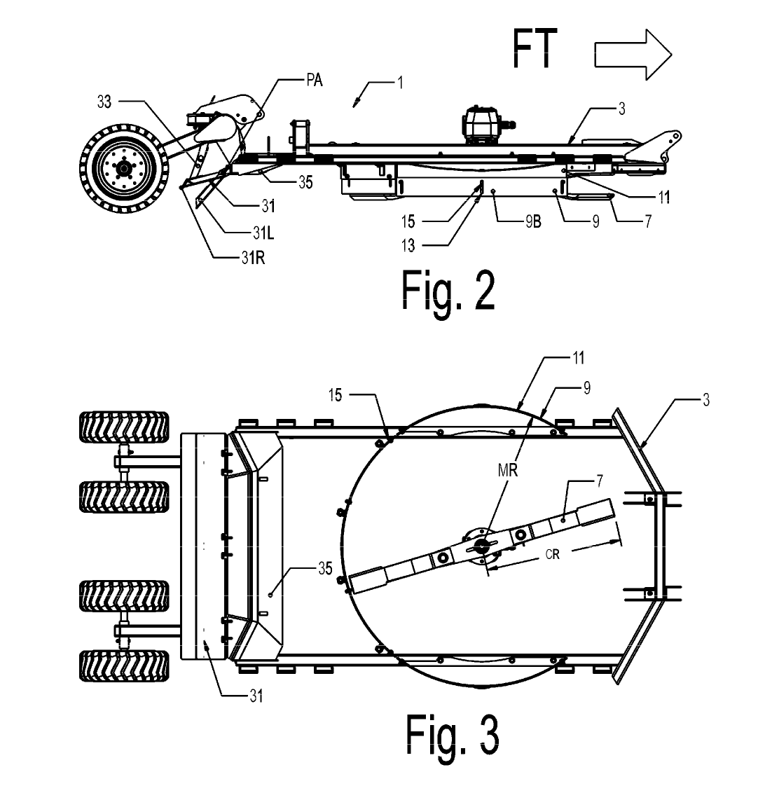

FIG. 1 illustrates a schematic bottom view of an embodiment of a rotary mower apparatus 1 of the present invention. FIG. 2 is a schematic side view of the apparatus 1, and FIG. 3 is schematic bottom view of one mower deck of the apparatus 1. The apparatus 1 comprises a mower deck 3 supported by rear wheels 5 and a hitch at a front end thereof adapted for attachment to a towing vehicle for operating movement in a forward travel direction FT. A plurality of mower blades 7 are rotatably mounted under the mower deck 3 about substantially vertical axes of rotation BA. The mower blades follow a circular path having a radius equal to a cutting radius CR.

A baffle plate 9 extends downward from the mower deck 3 adjacent to the circular path and outside the circular path such that the baffle plate is not contacted by the blade 7 as the blade 7 rotates, but such that the baffle plate 9 is in close proximity to the end of the blade 7. In the illustrated embodiment a mounting plate 11 extends downward from the mower deck 3 in an arc having a center substantially at the axis of rotation BA of the blade and having a radius MR greater than the cutting radius CR, and the baffle plate 9 has a similar arced configuration and follows and is attached to the mounting plate 11. Typically for example the cutting radius CR could be 36 inches and the radius of the mounting plate could be 37.5 or 38 inches, although it is contemplated that this difference could vary significantly and still provide some benefit in improving the evenness of the spread of cut material discharged from the apparatus 1.

As can be seen in FIG. 1 the mounting plate 11 and any attached baffle plate 9 extend around a rear portion of the blade 7, leaving the area under the mower deck 3 that is generally forward of the blade 7 open to allow vegetation to freely enter the cutting path of the blade 7 as the apparatus moves forward into standing vegetation that is being cut. The illustrated apparatus 1 shows the center baffle plate 9 extending around a greater arc of the blade than either of the outer right and left baffle plates 9. The degree of coverage will also vary with the particular mower, blade configuration, and like factors. It is also contemplated that the baffle plates 9 will in some applications be configured other than as a circular arc centered on the blade rotation axis BA.

FIGS. 2 and 3 illustrate the central section of the apparatus 1. The attachment of the baffle plate 9 to the mounting plate 11 is such that the baffle plate 9 can be adjusted up and down with respect to the mounting plate 11, so that the vertical position of a bottom edge 9B of the baffle plate 9 can be adjusted from a lowered position as illustrated in FIG. 2 to a raised position. The mounting plate 11 defines vertically oriented slotted holes 13 and bolts 15 are tightened in the slotted holes 13. Thus the baffle plate 9 can be vertically positioned anywhere in the range of the slotted holes 13, or removed completely.

FIG. 4 illustrates a configuration where the bottom edge 9B of a first end 17 of the baffle plate 9 is adjusted to a vertical location that is lower than a vertical location of the bottom edge 9B of a second end 19 thereof, such that the bottom edge 9B of the baffle plate 9 is oriented at an angle to the horizontal. In the configuration of FIG. 4 the second end 19 of the baffle plate 9 is in a raised position above the circular path of the blade 7, and the first end 17 of the baffle plate is in a lowered position below the circular path of the blade 7. The fit of the slotted holes 13 and bolts 15, as well as the fit of the baffle plate 9 and the mounting plate 11, can be somewhat loose to allow the angular orientation to be achieved.

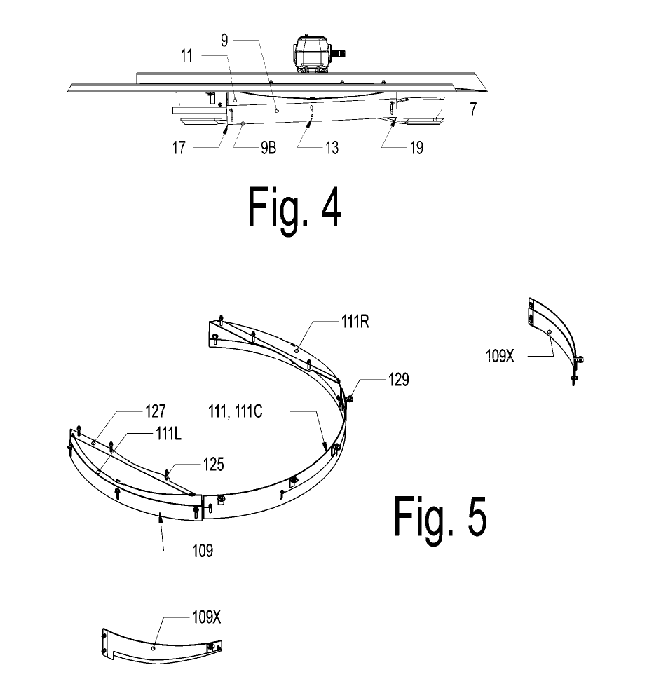

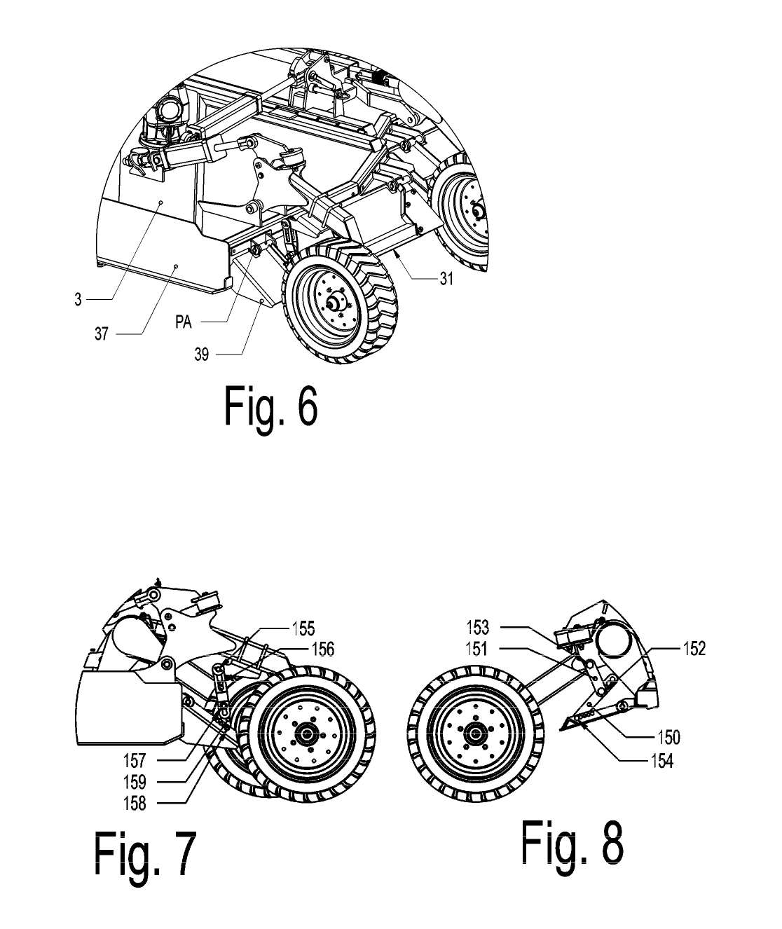

The mounting ring 11 can be welded to the under side of the mower deck 3, or can be bolted to the deck 3 as illustrated in the embodiment of FIG. 5 where the mounting ring 111 comprises three separate portions. The right and left mounting ring portions 111R, 111L are attached to the underside of the deck by bolts 125 welded to the mounting ring 111 via a cross brace 127 and inserted through corresponding holes in the deck. The cross brace 127 is configured to allow attachment of the mounting ring 111 to the center section of the mower as illustrated in FIG. 3, where the blade 7 extends beyond the edges of the center mower section and under the wing sections of the mower.

Flanges 129 are welded to the center mounting ring portion 111C, and bolts are inserted through corresponding holes in the deck and the flanges 129 to secure the center mounting ring portion 111C to the deck. FIG. 5 also illustrates a plurality of baffle plates 109, each individually adjustable up and down with respect to the mounting plate 111. FIG. 5 also shows baffle plates 109X wherein the bottom edge 109B is oriented at angle to a top edge thereof.

Thus the configuration and location of the baffle plates 9, 109 can be varied as required to control and direct the flow of cut material under the deck 3 such that when the material is discharged from the mower and the mower moves forward the evenness of the spread of cut material on the ground behind the mower is improved. When the vegetation being cut changes, as when the mower moves from a field of cotton crop residue into a field of corn crop residue for example, the location of the baffle plates 9, 109 can be changed as required to achieve an even spread of the new discharged cut material.

The apparatus 1 of FIGS. 1-3 also includes a deflector plate 31. The front edge of the deflector plate 31 is pivotally mounted about a substantially horizontal pivot axis PA to the mower deck 3 rearward of the mower blade 7 such that the deflector plate 31 extends downward and rearward from the front edge thereof. The deflector plate 31 can pivot from a lowered position 31L to a raised position 31R, and a support mechanism 33 is operative to support the deflector plate 31 at a selected location between the lowered and raised positions 31L, 31R.

In order to reduce damage and strain on the apparatus the deflector plate 31 will typically be supported by a mechanism operative to prevent downward movement of the deflector plate 31 and allow upward movement of the deflector plate 31, such that the deflector plate 31 can rise or float over obstructions, instead of being fixed in place. The weight of the deflector plate 31 will be sufficient to prevent debris from moving the deflector plate 31 up and allowing debris to be thrown out. The support mechanism could for example be provided by a chain.

Alternate embodiments of the support mechanism are illustrated in FIGS. 7 and 8. In FIG. 7 link 156 is pivotally attached by pin 155 through an upper slot in the link 156 to the mower deck through the wheel support. Bracket 159 is attached to the deflector plate by bolts or pins through one of a plurality of adjustment holes 158, and bolt 157 attaches the link 156 to the bracket 159, through a lower slot in the link 156. The vertical position of the deflector plate is varied by moving the bolt 157 along the lower slot and tightening same at a desired location, and also by moving the bracket 159 to a different adjustment hole 158.

In FIG. 8 upper link 151 is pivotally attached at the upper end thereof by a pin 153 to the mower deck through a wheel support member, and is pivotally attached at the lower end thereof to a midpoint of the lower link 150 by a pin 152 through one of a plurality of adjustment holes. The lower end of the lower link 150 is attached to the deflector plate by a pin 154 through one of a plurality of adjustment holes. The vertical position of the deflector plate is varied by putting the pins 152, 154 into different adjustment holes.

As best seen in FIG. 2, the mower deck 3 includes a rear wall 35 that slopes rearward and downward. The sloping rear wall 35 helps to smoothly direct cut material out the rear of the mower deck. Conventionally, a curtain of safety chains hangs substantially vertically down from the lower end of the rear wall 35, however in the apparatus 1 of the invention, the deflector plate 31 slopes rearward and downward behind the lower edge of the rear wall 35. Thus where the apparatus 1 is operating in a location where rocks or like debris thrown out the rear end of the mower deck 3 could cause damage, such as near roads, buildings, or where people might be present, the deflector plate 31 can be supported in the lowered position 31L where the deflector plate extends downward and rearward such that the bottom edge 31B of the deflector plate 31 is at about the same vertical location as the bottom ends of the chains in a curtain of safety chains.

In this position debris contacting the deflector plate 31 is directed down toward the ground and is prevented from flying out the rear end of the mower deck. In this position the deflector plate 31 provides improved safety over the conventional curtain of safety chains, while at the same time providing a smoothly sloped face that rearward thrown material contacts and then slides smoothly down and out the rear end of the deck 3. Material flow is significantly improved over the conventional mower where rearward thrown material contacts the substantially vertically hanging safety chains and drops down to the ground. This moving material moves the safety chains rearward somewhat, but the safety chains, in order to be effective in slowing or stopping thrown debris, are quite heavy, and where the material flow is heavy, the chains can drag the material into piles.

When the apparatus 1 is operating in an open field, where the operator can easily see if anything is present that might be damaged by debris thrown out the rear end of the mower, the deflector plate 31 can be moved up to the raised position 31R, and material can flow freely out the rear end of the mower, thus improving the evenness of spread of the discharged material, especially where the material flow is heavy.

In order to prevent debris from being thrown out of the mower at the outside end of the deflector plate 31, adjacent to the sidewall 37 of the mower deck 3, an end plate 39 is provided extending forward from the outside end of the deflector plate 31 to a location adjacent to an inside surface of the sidewall 37 of the mower deck 3. Thus as the deflector plate 31 pivots up and down about the pivot axis PA, the end plate 39 moves back and forth adjacent to the inside surface of the sidewall 37 and blocks the gap that would otherwise be present between the end of the deflector plate 31 and the end of the sidewall. 37.

The foregoing is considered as illustrative only of the principles of the invention. Further, since numerous changes and modifications will readily occur to those skilled in the art, it is not desired to limit the invention to the exact construction and operation shown and described, and accordingly, all such suitable changes or modifications in structure or operation which may be resorted to are intended to fall within the scope of the claimed invention.

1. A rotary mower apparatus comprising:
a mower deck;
a mower blade rotatably mounted under the mower deck about a substantially vertical axis of rotation, wherein the mower blade follows a circular path having a radius equal to a cutting radius;
a baffle plate extending downward from the mower deck adjacent to the circular path and outside the circular path;
wherein a vertical position of a bottom edge of the baffle plate can be adjusted from a lowered position to a raised position.

2. The apparatus of claim 1 wherein the baffle plate is configured in an arc having a center substantially at the axis of rotation of the blade and having a radius greater than the cutting radius.

3. The apparatus of claim 1
wherein the raised position of the baffle plate is above the circular path.

4. The apparatus of claim 1 wherein the baffle plate is removable.

5. The apparatus of claim 1 comprising a mounting plate extending downward from the mower deck in an arc having a center substantially at the axis of rotation of the blade and having a radius greater than the cutting radius, and wherein the baffle plate is attached to the mounting plate such that the baffle plate can be adjusted up and down with respect to the mounting plate.

6. The apparatus of claim 5 comprising a plurality of baffle plates, each individually adjustable up and down with respect to the mounting plate.

7. The apparatus of claim 5 wherein one of the mounting plate and at least one baffle plate defines vertically oriented slotted holes.

8. The apparatus of claim 1 wherein the bottom edge of a first end of at least one baffle plate can be adjusted to a vertical location that is different than a vertical location of the bottom edge of a second end thereof, such that the bottom edge of the at least one baffle plate is oriented at an angle to the horizontal.

9. The apparatus of claim 8 wherein the bottom edge of the at least one baffle plate is oriented at angle to a top edge thereof.

10. The apparatus of claim 1 further comprising:
a deflector plate having a front edge pivotally mounted about a substantially horizontal pivot axis to the mower deck rearward of the mower blade such that the deflector plate extends downward and rearward from the front edge thereof, and such that the deflector plate can pivot from a lowered position to a raised position; and
a support mechanism operative to support the deflector plate at a selected location between the lowered and raised positions.

11. The apparatus of claim 10 wherein the support mechanism is operative to prevent downward movement of the deflector plate and allow upward movement of the deflector plate.

12. The apparatus of claim 10 wherein the mower deck includes a rear wall that slopes rearward and downward from a top edge thereof.

13. The apparatus of claim 10 further comprising an end plate extending forward from an outside end of the deflector plate to a location adjacent to an inside surface of a sidewall of the mower deck such that as the deflector plate pivots up and down the end plate moves adjacent to the inside surface of the sidewall.

14. A rotary mower apparatus comprising:
a mower deck;
a mower blade rotatably mounted under the mower deck about a substantially vertical axis of rotation;
a deflector plate having a front edge pivotally mounted about a substantially horizontal pivot axis to the mower deck rearward of the mower blade such that the deflector plate extends downward and rearward from the front edge thereof, and such that the deflector plate can pivot in a pivot range from a lowered position to a raised position; and
a support mechanism operative to support the deflector plate at a selected location in the pivot range.

15. The apparatus of claim 14 wherein the support mechanism is operative to prevent downward movement of the deflector plate and allow upward movement of the deflector plate.

16. The apparatus of claim 14 wherein the mower deck includes a rear wall that slopes rearward and downward from a top edge thereof.

17. The apparatus of claim 14 further comprising an end plate extending forward from an outside end of the deflector plate to a location adjacent to an inside surface of a sidewall of the mower deck such that as the deflector plate pivots up and down the end plate moves adjacent to the inside surface of the sidewall.

18. The apparatus of claim 14 wherein the mower blade follows a circular path having a radius equal to a cutting radius and comprising a baffle plate extending downward from the mower deck adjacent to the circular path and outside the circular path, wherein a vertical position of a bottom edge of the baffle plate can be adjusted from a lowered position to a raised position.

19. The apparatus of claim 18 wherein the baffle plate is configured in an arc having a center substantially at the axis of rotation of the blade and having a radius greater than the cutting radius.

20. The apparatus of claim 18 wherein the baffle plate is removable.

21. The apparatus of claim 18 comprising a mounting plate extending downward from the mower deck in an arc having a center substantially at the axis of rotation of the blade and having a radius greater than the cutting radius, and wherein the baffle plate is attached to the mounting plate such that the baffle plate can be adjusted up and down with respect to the mounting plate.

22. The apparatus of claim 21 comprising a plurality of baffle plates, each individually adjustable up and down with respect to the mounting plate.

23. The apparatus of claim 21 wherein one of the mounting plate and at least one baffle plate defines vertically oriented slotted holes.

24. The apparatus of claim 18 wherein the bottom edge of a first end of at least one baffle plate can be adjusted to a vertical location that is different than a vertical location of the bottom edge of a second end thereof, such that the bottom edge of the at least one baffle plate is oriented at an angle to the horizontal.

25. The apparatus of claim 24 wherein the bottom edge of the at least one baffle plate is oriented at angle to a top edge thereof.
